(19) United States
(12) Patent Application Publication
(10) Pub. No.: US 2016/0190559 A1
(43) Pub. Date: Jun. 30, 2016

(54) COATED LITHIUM-RICH LAYERED OXIDES AND PREPARATION THEREOF

(71) Applicant: ROBERT BOSCH GMBH, Stuttgart (DE)

(72) Inventors: Mengyan Hou, Shanghai (CN); Yonggang Wang, Shanghai (CN); Roger Zhou, Shanghai (CN); Rongrong Jiang, Shanghai (CN); Jinlong Liu, Shanghai (CN); Yongyao Xia, Shanghai (CN)

(21) Appl. No.: 14/907,440

(22) PCT Filed: Jul. 23, 2013
(86) PCT No.: PCT/CN2013/079914

§ 371 Date: Jan. 25, 2016

(51) Int. Cl. H01M 4/36; H01M 4/04; H01M 4/505; H01M 4/525; H01M 10/0525; H01M 4/485

(52) U.S. Cl. CPC H01M 4/366; H01M 10/0525; H01M 4/485; H01M 4/505; H01M 4/525; H01M 4/0421

(57) ABSTRACT

A coated lithium-rich layered oxide consisting of: a lithium-rich layered oxide represented by the formula xLi₂MO₃(1−x) LiM′O₂, wherein M is Mn, Ti, Zr or any combination thereof, M′ is Mn, Ni, Co or any combination thereof, and 0<x<1, and an outer layer formed by gas deposition of P₂O₅. A process for producing the coated lithium-rich layered oxide, a cathode comprising the coated lithium-rich layered oxide, and a rechargeable lithium battery.

### TECHNICAL FIELD

The present invention relates to coated lithium-rich layered oxides, especially, a lithium-rich layered oxide of xLi₂MO₃-(1−x)LiM′O₂ (wherein M is Mn, Ti, Zr or any combination thereof; M′ is Mn, Ni, Co or any combination thereof; 0<x<1) coated by a layer formed from gas deposition of P₂O₅; and to the preparation thereof.

### BACKGROUND ARTS

Lithium batteries are widely used at present due to their relatively high energy density.

Anode and cathode are important building blocks of the lithium batteries. However, the capacity of cathode materials is much less than that of anode materials. For some current commercial batteries, cathode materials such as LiCoO₂, LiNiO₂, LiMn₂O₄, LiFePO₄ and the like are used, however, these materials have a low capacity of less than 200 mAh/g.

Now, lithium-rich layered oxides xLi₂MO₃·(1−x)LiM′O₂ (M is Mn, Ti, Zr or any combination thereof; M′ is Mn, Ni, Co or any combination thereof; 0≦x≦1) have drawn much attention because of their large reversible discharge capacity. However, such materials suffer from low first cycle efficiency, inferior performance at low temperatures and poor rate capabilities. Surface modification has been employed to circumvent these obstacles, but it has limitations owing to the requirements for post-treatment and the lack of breakthroughs. In the past years, many different compounds, such as oxides (Al₂O₃, ZnO, TiO₂), phosphates (AlPO₄, LiNiPO₄, LiCoPO₄) and fluorides (AlF₃), have been employed for surface modification of this kind of materials to improve their electrochemical performances. For example, Kang S. H. et al (Electrochemistry Communications, 11, (2009), 748-751) demonstrated that LiNiPO₄ coated 0.5Li₂MnO₃·0.5LiNi_{1/3}CO_{1/3}Mn_{1/3}O₂ showed improved rate capability in comparison with the pristine material. The improved rate capability is due to that LiNiPO₄ layer at the surface not only acts as an excellent Li⁺-ion conductor but also serves as the protective layer at high potentials (4.6 V vs.)Li⁰.

Surface modification as reported in the prior arts was carried out in the solution through a wet-chemical method. Although the surface treatment with various compounds through the wet-chemical method has been proved to be effective to improve the electrochemical performances of the materials, it remains difficult to get a homogenous coating layer by a simple chemical method.

### SUMMARY OF THE INVENTION

It is an object of the invention to provide a coated lithium-rich layered oxide consisting of a lithium-rich layered oxide represented by the formula xLi₂MO₃·(1−x)LiM′O₂, wherein M is Mn, Ti, Zr or any combination thereof, M′ is Mn, Ni, Co or any combination thereof, and 0<x<1; and an outer layer formed by gas deposition of P₂O₅. Said coated lithium-rich layered oxide has a uniform and continuous outer layer and contributes to significant improvements in first cycle coulombic efficiency (FCE), specific discharge capacity and rate capability.

It is another object of the invention to provide a process for producing the coated lithium-rich layered oxide, which comprises: contacting a lithium-rich layered oxide powder with P₂O₅ gas at a temperature in a range of 300° C. to 500° C., wherein said lithium-rich layered oxide is represented by the formula xLi₂MO₃·(1−x)LiM′O₂, wherein M is Mn, Ti, Zr or any combination thereof, M′ is Mn, Ni, Co or any combination thereof, and 0<x<1. Said process, compared with the conventional coating methods, produces a more homogeneous coating around the oxide through a simple in-situ gas-solid reaction, and provides a coated lithium-rich layered oxide exhibiting an excellent electrochemical performance compared with the uncoated one.

It is still another object of the invention to provide a cathode comprising the coated lithium-rich layered oxide of the invention.

It is still another object of the invention to provide a rechargeable lithium battery comprising a cathode comprising the coated lithium-rich layered oxide of the invention.

### BRIEF INTRODUCTION OF THE DRAWINGS

FIG. 1 shows TEM images of the P₂O₅ treated Li_{1.2}Mn_{0.54}Ni_{0.13}Co_{0.13}O₂ from Example 1.

FIG. 2 shows EDX spectrum of the P₂O₅ treated Li_{1.2}Mn_{0.54}Ni_{0.13}Co_{0.13}O₂ from Example 2.

FIG. 3 shows the first cycle charge/discharge curves of the P₂O₅ treated and untreated Li_{1.2}Mn_{0.54}Ni_{0.13}Co_{0.13}O₂ from Example 2 and Example A.

FIG. 4 shows the comparison of rate capabilities at room temperature between the P₂O₅ treated and untreated Li_{1.2}Mn_{0.54}Ni_{0.13}Co_{0.13}O₂ from Example 1 and Example A.

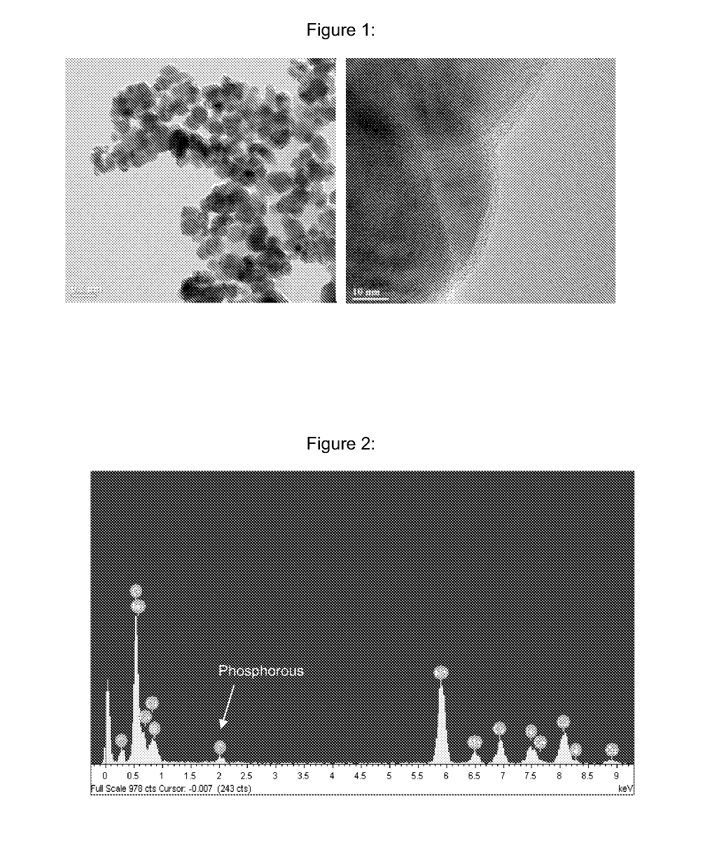

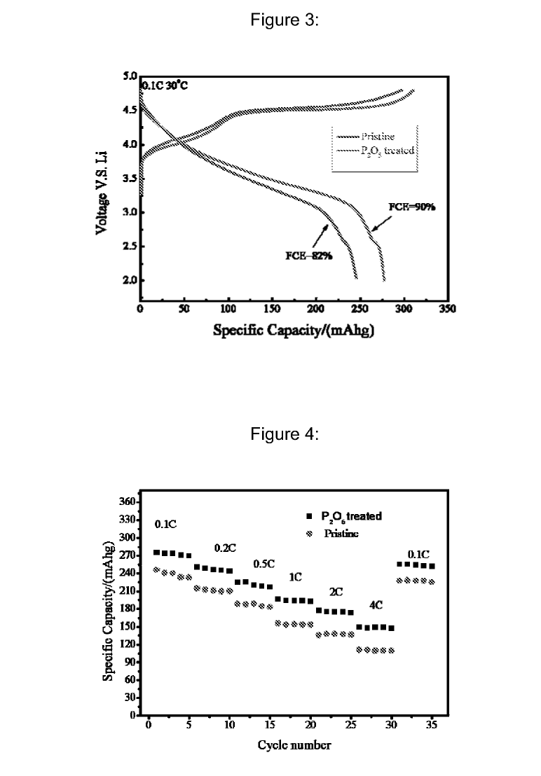

### DETAILED DESCRIPTION OF THE INVENTION

The present invention will be described in details as followings. The materials, methods, and examples herein are illustrative only and, except as specifically stated, are not intended to be limiting. Although methods and materials similar or equivalent to those described herein can be used in the practice or testing of the present invention, suitable methods and materials are described herein.

All publications and other references mentioned herein are explicitly incorporated by reference in their entirety.

Unless otherwise defined, all technical and scientific terms used herein have the same meanings as commonly understood by those skilled in the art. In case of conflict, the present specification, including definitions, will control.

Unless stated otherwise, all percentages, parts, ratios, etc., are by weight.

Where a range of numerical values are recited herein, unless otherwise stated, the range is intended to include the endpoints thereof, and all integers and fractions within the range.

Use of “a” or “an” is employed to describe elements and components of the present invention. This is done merely for convenience and to give a general sense of the invention. This description should be read to include one or at least one and the singular also includes the plural unless it is obvious that it is meant otherwise.

Other than in the operating examples, or where otherwise indicated, all numbers expressing quantities of ingredients, reaction conditions, or defining ingredient parameters used herein are to be understood as modified in all instances by the term “about”.

The term “normal pressure” used herein means about 0.1 MPa. The term “room temperature” used herein means about 25° C.

As used herein, the term “coated lithium-rich layered oxide” may also be understood as a “shell-core structured lithium-rich layered oxide”, and they can be used interchangeably in the present application.

The term “gas deposition” used herein means that P₂O₅ gas reacts with lithium-rich layered oxides and thereby, an outer layer on the surface of the lithium-rich layered oxides is formed. The composition of the outer layer was not completely studied but assumed to comprise phosphates of the metals contained in the lithium-rich layered oxides, such as, phosphates of Li, Mn, Ti, Zr, Ni and/or Co.

As mentioned above, one aspect of the invention is to provide a coated lithium-rich layered oxide consisting of:
a lithium-rich layered oxide represented by the formula xLi₂MO₃·(1−x)LiM′O₂, wherein M is Mn, Ti, Zr or any combination thereof, M′ is Mn, Ni, Co or any combination thereof, and 0<x<1; and
an outer layer formed by gas deposition of P₂O₅.

Although any lithium-rich layered oxide(s) falling in the range of the above formula xLi₂MO₃·(1−x)LiM′O₂ may be used in the present invention, mentioned may be the lithium-rich layered oxide represented by the formula xLi₂MnO₃·(1−x)LiNi_{y}Co_{z}Mn_{1-y-z}O₂, wherein 0<x<1, 0<y<1, and 0<z<1; for example, x=0.2, 0.3, 0.4, 0.5, 0.6, 0.7, 0.8 or 0.9; y=0.2, 0.3, ⅓, 0.4, 0.5, 0.6, 0.7, or 0.8; z=0.1, 0.2, 0.3, ⅓, 0.4, or 0.5.

The lithium-rich layered oxide may be used in any shape of particles, for example, spherical, sheet-like, or irregular particles. Further, the lithium-rich layered oxide particle may be in a form of primary particles or secondary particles. The size of the lithium-rich layered oxide particle can be any commonly used sizes in the art; for primary particles, for example, 50 nm to 800 nm, or 100 nm to 500 nm.

The lithium-rich layered oxide used in the invention may be prepared by traditional preparation processes, such as the co-precipitation process.

In an embodiment of the invention, x is 0.5, y is ⅓, and z is ⅓; or x is 0.7, y is ⅓, and z is ⅓; or x is 0.3, y is ⅓, and z is ⅓.

In an embodiment of the invention, the outer layer may have a thickness of, for example, 1 nm to 30 nm, 1 nm to 20 nm, or 2 nm to 10 nm.

In an embodiment of the invention, the outer layer may cover 20% to 100% of the total surface of the lithium-rich layered oxide particle, preferably, 40% to 100%, or 60% to 100%, or 80% to 100%, or 90% to 100%, or 95% to 100%, or 98% to 100% of the total surface of the lithium-rich layered oxide particle.

Another aspect of the invention is to provide a method for producing the coated lithium-rich layered oxide, comprising: contacting a lithium-rich layered oxide powder with P₂O₅ gas at a temperature in a range of 300° C. to 500° C., wherein said lithium-rich layered oxide is represented by the formula xLi₂MO₃·(1−x)LiM′O₂, wherein M is Mn, Ti, Zr or any combination thereof, M′ is Mn, Ni, Co or any combination thereof, and 0<x<1.

In the method of the invention, any lithium-rich layered oxide(s) falling in the range of the above formula xLi₂MO₃·(1−x)LiM′O₂ may be used. Especially, the lithium-rich layered oxide represented by the formula xLi₂MnO₃·(1−x)LiNi_{y}Co_{z}Mn_{1-y-z}O₂, wherein 0<x<1, 0<y<1, and 0<z<1; for example, x=0.2, 0.3, 0.4, 0.5, 0.6, 0.7, 0.8 or 0.9, y=0.2, 0.3, ⅓, 0.4, 0.5, 0.6, 0.7, or 0.8; z=0.1, 0.2, 0.3, ⅓, 0.4, or 0.5, may be used in the method of the invention. In a specific embodiment of the method of the invention, xLi₂MnO₃·(1−x)LiNi_{y}Co_{z}Mn_{1-y-z}O₂, wherein x is 0.5, y is ⅓, and z is ⅓; or x is 0.7, y is ⅓, and z is ⅓; or x is 0.3, y is ⅓, and z is ⅓ may be used.

The P₂O₅ gas reacts with lithium-rich layered oxides for example, at an elevated temperature of 300-500° C., so as to forms a uniform and continuous layer on the surface of lithium-rich layered oxides, which is called “gas deposition” in the context. The P₂O₅ gas may be obtained from the sublimation of solid P₂O₅ and/or the evaporation of liquid P₂O₅.

The thickness of the outer layer depends on the time experienced in the gas deposition and the amount of P₂O₅ used. Although the thickness of the outer layer is not particularly limited, mentioned may be, for example, 1 nm to 30 nm, 1 nm to 20 nm, 2 nm to 10 nm.

In the contacting of the lithium-rich layered oxide with P₂O₅ gas, an inert atmosphere should be ensured so as to avoid entrapping substances reactive to the oxide and P₂O₅, for example, moisture. The inert atmosphere may be achieved by mixing the powder of the lithium-rich layered oxide with solid P₂O₅ in an inert atmosphere, such as, argon atmosphere, and then introducing the mixture into a sealed container.

The contacting of the lithium-rich layered oxide with P₂O₅ gas may be carried out in a static condition or in a dynamic condition. As for the static condition, the lithium-rich layered oxide is kept static when contacting with P₂O₅ gas. As for the dynamic condition, when contacting with P₂O₅ gas, the lithium-rich layered oxide may be moved continuously or discontinuously in any manners suitable in the art, for example, it may be shaken or rotated continuously or discontinuously.

The time for the contacting of the lithium-rich layered oxide with P₂O₅ gas under an inert atmosphere is not particularly limited as long as a suitable thickness and coverage of the outer layer may be formed. For example, mentioned may be 15 minutes to 15 hours, 30 minutes to 10 hours, or 1 hour to 6 hours.

In a specific embodiment of the invention, the method comprises the steps of:
under an inert atmosphere, mixing the powder of the lithium-rich layered oxide with solid P₂O₅ and transferring the mixture into a sealable reactor which is then sealed;
placing the sealed reactor into a furnace preheated to a temperature in the range of 300° C. to 500° C. to heattreat the mixture for 15 minutes to 15 hours; and
cooling down, optionally followed by washing and drying the obtained product.

In the method of the invention, the mixing and transferring may be carried out in a manner known to those skilled in the art as long as it is under an inert atmosphere. For example, the mixing and transferring are carried out in a glove box filled with argon gas. Even though the temperature and pressure during the mixing and transferring are not particularly limited, the room temperature and normal pressure are preferred from the view point of easy handling.

The mixing ratio between the solid P₂O₅ and the lithium-rich layered oxide powder is not particularly limited as long as a suitable thickness and coverage of the outer layer may be formed. In an embodiment of the method, the weight ratio between solid P₂O₅ and the lithium-rich layered oxide powder is in a range of 1:99 to 20:80, or 1:99 to 5:95. For example, the weight ratio between solid P₂O₅ and the lithium-rich layered oxide powder may be 1:99, 10:90 and 3:97.

As mentioned above, the outer layer is formed by the gas deposition of P₂O₅. Via the gas deposition, a more uniform and continuous layer may be formed compared with the solution deposition. That is to say, during the formation of the outer layer, P₂O₅ has to be in a gas form.

Moreover, in order to form a suitable thickness and coverage of the outer layer, the heat treatment has to be conducted for a certain time period, for example, 30 minutes to 10 hours, such as 1 hour to 6 hours.

The heat treatment may be carried out in any suitable furnace known to those skilled in the art, for example, Muffle furnace.

After the heat treatment, the obtained product is cooled down to a temperature suitable for the next procedure, for example, 10° C-90° C., 20° C.-60° C., or about room temperature. Cooling to about room temperature is preferred from the view point of easy handling. Then, the cooled product may be optionally washed to remove unreacted P₂O₅, for example, with water, or other suitable solvents. Further, the washed product may be dried at room temperature or a little higher temperature, for example, 25-50° C.

Still another aspect of the invention is to provide a cathode comprising the coated lithium-rich layered oxide of the invention. Said cathode may exhibit significant improvements in first cycle coulombic efficiency (FCE), specific discharge capacity and rate capability.

Still another aspect of the invention is to provide a rechargeable lithium battery comprising a cathode comprising the cathode of the invention. Said rechargeable lithium battery has excellent properties.

### EXAMPLES

The present invention will be further described and illustrated in details with reference to the following examples, which, however, are not intended to restrict the scope of the present invention.

### Preparation of Lithium-Rich Layered Oxides

### Example A

### Preparation of xLi₂MnO₃·(1−x)LiNi_{y}Co_{z}Mn_{1-y-z}O₂ (x=0.5; y=⅓; z=⅓)

Firstly, (Ni_{1/3}CO_{1/3}Mn_{1/3})(OH)₂ was synthesized by the co-precipitation method. Specifically, an aqueous solution of NiSO₄, CoSO₄ and MnSO₄ (molar ratio of Mn:Ni:Co=4:1:1) with a SO₄²⁻ concentration of 2.0 mol L⁻¹ was pumped into a reactor. At the same time, NaOH solution (aq.) of 2.0 mol L⁻¹ and desired amount of NH₄OH solution (aq.) were also pumped into the reactor separately. The pH, temperature, and stirring speed of the mixture were controlled with care so as to obtain the mixed hydroxides.

Then the precipitated mixed hydroxides were filtered, washed thoroughly with deionized water for several times and dried at 110° C. overnight in air. Then the obtained precursor and LiOH·H₂O with a molar ratio of 1:1.05 (5 wt % excess of LiOH·H₂O was to offset the evaporative loss of lithium) were mixed homogenously, then sintered at 900° C. in air for 10 h, and then quenched to room temperature with liquid nitrogen. The obtained lithium-rich layered oxide was xLi₂MnO₃ (1−x)LiNi_{y}Co_{z}Mn_{1-y-z}O₂ wherein x=0.5; y=⅓; and z=⅓.

### Example B

### Preparation of xLi₂MnO₃·(1−x)LiNi_{y}Co_{z}Mn_{1-y-z}O₂ (x=0.7; y=⅓; z=⅓)

The process was the same as Example A except that the molar ratio of Mn:Ni:Co was 8:1:1. The obtained lithium-rich layered oxide was xLi₂MnO₃·(1-x)LiNi_{y}Co_{z}Mn_{1-y-z}O₂ wherein x=0.7; y=⅓; and z=⅓.

### Example C

### Preparation of xLi₂MnO₃·(1−x)LiNi_{y}Co_{z}Mn_{1-y-z}O₂ (x=0.3; y=⅓; z=⅓)

The process was the same as Example A except that the molar ratio of Mn:Ni:Co was 16:7:7. The obtained lithium-rich layered oxide was xLi₂MnO₃·(1−x)LiNi_{y}Co_{z}Mn_{1-y-z}O₂ wherein x=0.3; y=⅓; and z=⅓.

### Preparation of Coated Lithium-Rich Layered Oxides

### Example 1

99 g of the lithium-rich layered oxide powder obtained in the above Example A and 1 g of solid P₂O₅ were mixed together in a glove box filled with argon gas under normal pressure at room temperature, and the mixture was then immediately transferred to a sealable reactor which was then sealed. Thereafter, the sealed reactor was placed into a Muffle furnace preheated to 310° C. The temperature of 310° C. was kept constant, and the heat treatment was conducted for 1 hour. The obtained coated lithium-rich layered oxide was cooled down to room temperature, and then washed with water and dried. Then, the dried product was used to produce the cathode for test.

### Production of the Cathode and Performances Test

Lithium-rich layered oxide powder, carbon black and polyvinylidene fluoride (PVDF), which are active materials of the cathode, were mixed with a weight ratio of 80˜94:10˜3:10˜3. Then N-methyl-2-pyrrolidone (NMP) was added to these active materials as a solvent to form a slurry. The slurry was then uniformly coated on an aluminum foil, dried at 100° C. under vacuum for 10 h, pressed and cut into 12 mm cathode discs. Coin cells (CR2016) were assembled using metallic Li as the counter electrode, Celgard 2400 (from Celgard) as the separator, and 1mol L⁻¹ LiPF₆ as the electrolyte, in an Ar-filled glove box.

The cycling performances of the cells including the FCE (first cycle columbic efficiency), the discharge capacity and the capacity retention were evaluated by using Land CT2001A battery tester (from WUHAN LAND ELECTRONICS Co. Ltd.) between 2.0V and 4.8V versus Li/Li+; wherein the FCE was defined by the first cycle discharge capacity over the first charge capacity, the discharge capacity was tested at the rate of 0.1 C at 30° C., and the capacity retention of the discharge capacity at 10 over the discharge capacity at 0.1 C was tested at room temperature.

The test results of the electrochemical performances of the produced cathode are shown in Table 1.

### Example 2

Example 2 was conducted substantially the same as that described in Example 1, except that 90 g of the lithium-rich layered oxide from Example A and 10 g of solid P₂O₅ were used and the heat treatment was conducted at 500° C. for 3 hours. The test methods were the same as those of Example 1. The test results of the electrochemical performances of the produced cathode are shown in Table 1.

### Example 3

Example 3 was conducted substantially the same as that described in Example 2, except that 90 g of the lithium-rich layered oxide from Example B and 10 g of solid P₂O₅ were used. The test methods were the same as those of Example 1. The test results of the electrochemical performances of the produced cathode are shown in Table 1.

### Example 4

Example 4 was conducted substantially the same as that described in Example 1, except that 97 g of the lithium-rich layered oxide from Example C and 3 g of solid P₂O₅ were used and the heat treatment was conducted at 300° C. for 5 hours. The test methods were the same as those of Example 1. The test results of the electrochemical performances of the produced cathode are shown in Table 1.

TABLE 1
results of the performance tests of each cathode material

| | performances | | |
|---|---|---|---|
| | FCE | Discharge capacity | Capacity retention |
| Products | coated/ | (mAh/g) 0.1 C | 1 C/0.1 C |
| coated/uncoated | uncoated | coated/uncoated | coated/uncoated |
| Example 1/Example A | 90%/82% | 276/248 | 72%/65% |
| Example 2/Example A | 94%/81% | 272/250 | 73%/64% |
| Example 3/Example B | 84%/65% | 261/232 | 58%/44% |
| Example 4/Example C | 96%/85% | 217/208 | 78%/72% |

It can be seen from Table 1 that compared with uncoated ones, the FCE, the discharge capacity and the capacity retention of the coated ones of the invention are significantly improved.

The present invention is illustrated in details in the embodiments; however, it is apparent for those skilled in the art to modify and change the embodiments without deviating from the spirit of the invention. All the modifications and changes should fall in the scope of the appended claims of the present application.

1. A coated lithium-rich layered oxide, consisting of:
a lithium-rich layered oxide represented by the formula xLi₂MO₃·(1−x)LiM′O₂, wherein M is Mn, Ti, Zr or any combination thereof, M′ is Mn, Ni, Co or any combination thereof, and 0<x<1; and
an outer layer formed by gas deposition of P₂O₅.

2. The coated lithium-rich layered oxide according to claim 1, wherein the outer layer has a thickness of 1 nm to 30 nm, 1 nm to 20 nm, or 2 nm to 10 nm.

3. The coated lithium-rich layered oxide according to claim 1, wherein the outer layer covers 20% to 100%, 40% to 100%, 60% to 100%, 80% to 100%, 90% to 100%, 95% to 100%, or 98% to 100% of the total surface of the lithium-rich layered oxide.

4. The coated lithium-rich layered oxide according to claim 1, wherein the lithium-rich layered oxide is represented by the formula xLi₂MnO₃·(1−x)LiNi_{y}Co_{z}Mn_{1-y-z}O₂, wherein 0<x<1, 0<y<1, and 0<z<1; such as, x=0.2, 0.3, 0.4, 0.5, 0.6, 0.7, 0.8 or 0.9; y=0.2, 0.3, ⅓, 0.4, 0.5, 0.6, 0.7, or 0.8; z=0.1, 0.2, 0.3, ⅓, 0.4, or 0.5.

5. A process for producing a coated lithium-rich layered oxide, comprising:
contacting a lithium-rich layered oxide powder with P₂O₅ gas at a temperature in a range of 300° C. to 500° C.; wherein said lithium-rich layered oxide is represented by the formula xLi₂MO₃·(1−x)LiM′O₂, wherein M is Mn, Ti, Zr or any combination thereof, M′ is Mn, Ni, Co or any combination thereof, and 0<x<1.

6. The process according to claim 5, comprising the steps of:
under an inert atmosphere, mixing the powder of the lithium-rich layered oxide with solid P₂O₅ and transferring the mixture into a sealable reactor which is then sealed;
placing the sealed reactor into a furnace preheated to a temperature in the range of 300° C. to 500° C. to heattreat the mixture for 15 minutes to 15 hours; and
cooling down, optionally followed by washing and drying the obtained product.

7. The process according to claim 6, wherein the mixing and transferring are carried out under argon gas.

8. The process according to claim 6, wherein the heat treatment is carried out for 30 minutes to 10 hours, or 1 hour to 6 hours.

9. The process according to claim 5, wherein the lithium-rich layered oxide is represented by the formula xLi₂MnO₃·(1−x)LiNi_{y}CO₂Mn_{1-y-z}O₂, wherein 0<x<1, 0<y<1, and 0<z<1; such as, x=0.2, 0.3, 0.4, 0.5, 0.6, 0.7, 0.8 or 0.9; y=0.2, 0.3, ⅓, 0.4, 0.5, 0.6, 0.7, or 0.8; z=0.1, 0.2, 0.3, ⅓, 0.4, or 0.5.

10. The process according to claim 6, wherein the weight ratio between solid P₂O₅ and the powder of the lithium-rich layered oxide is in a range of 1:99 to 20:80, or 1:99 to 5:95.

11. A cathode comprising the coated lithium-rich layered oxide according to claim 1.

12. A rechargeable lithium battery comprising a cathode of claim 11.

13. A cathode obtained from the process according claim 5.
